(19) United States
(12) Patent Application Publication
(10) Pub. No.: US 2010/0096322 A1
(43) Pub. Date: Apr. 22, 2010

(54) METHOD FOR THE BIOLOGICAL CLEANING OF OIL CONTAMINATED BOTTOM SEDIMENTS

(76) Inventors: Sergei Valereivich Lushnikov, Tomsk (RU); Danil Sergeevich Vorobiev, Tomsk (RU); Nikolay Aleksandrovich Zalozny, Tomsk (RU); Yulia Aleksandrovna Frank, Tomsk (RU)

Correspondence Address: Todd Rushton, 1040 Bountiful Blvd., Bountiful, UT, 84010, US

(21) Appl. No.: 12/641,699

(22) Filed: Dec. 18, 2009

Related U.S. Application Data
(63) Continuation-in-part of application No. PCT/RU2008/000390, filed on Jun. 23, 2008.

(51) Int. Cl. C02F 3/32

(52) U.S. Cl. 210/602

(57) ABSTRACT

This invention is focused on protecting the environment, more specifically, on methods for cleaning oil-contaminated bottom sediments and also sludge pits and oil refinery sewage tanks. For realization of this method, after preliminary extraction of liquid fraction of oil from the bottom of the reservoir, place oligochaetes of the family Tubificidae in quantities from 20 up to 65 g/m², create a level of concentration of dissolved oxygen in benthic layers of water by aeration of reservoirs through the use of aerating devices and simultaneously administer nitric and phosphoric mineral fertilizers to maintain a concentration of phosphorus in water of 0.5-1.5 mg/dm³ and nitrogen no more than 2 mg/dm³.

This application is a Continuation-in-part of International Application Number PCT/RU2008/000390, filed in the English language on Jun. 23, 2008. The disclosure of Application PCT/RU2008/000390 is incorporated by reference under 37 CFR 1.57.

### BACKGROUND

This invention is focused on protecting the environment, more specifically, on a method for cleaning oil-contaminated bottom sediments and also sludge pits and oil refinery sewage tanks.

There already exist various well-known methods for cleaning bottom sediments (e.g.: Russian Federation patent 2246451 MΠK 7 C02F 11/02). One method for cleaning bottom sediments is carried out through the removal of water from the bottom sediments and then heat treatment of the sediments with hot water at 80° C. for 24 hours (3 times). Then anaerobic biological cleaning at temperature 20-25° C. for 20 days and then aerobic stabilization in the presence of air at 20-30° C. for 24 hours. After biological cleaning the sediment is mixed with clean soil and sawdust in a ratio 1:1:1 and subject it to a final aerobic cleaning by a bacterial biomass. The residual concentration of hydrocarbons of oil in the final mix is from 0.26% by weight (2.6 g/kg) up to 0.71% by weight (7.1 g/kg).

A difficulty arises in finding effective methods for the extraction of contaminated bottom sediments from a reservoir, for maintaining strict observance of the necessary temperatures during cleaning, and for the formulation of the mix of extracted bottom sediments with clean soil and sawdust. All of which contribute to increased difficulty/complication associated with this cleaning method.

An alternative method for treating water in reservoirs and oil-contaminated bottom sediments (Russian Federation patent 2260652 MΠK 7 E02B 15/04, C02F 1/28) is also well-known. In order to treat reservoir water, a mat constructed of cotton or synthetic fabric which is filled with cleaning substances made of aluminosilicate, organic substances and mineral fertilizers is placed on the surface of the water where the active slick is located. During the cleaning process bottom sediments are floated from the bottom into the water. This method allows oil-contaminated bottom sediments to be cleaned to a residual concentration of 2.6 g/kg.

The most prominent shortcoming of this method is the absence of any direct cleaning of the bottom sediments, and thus, the biodeterioration of oil in the bottom sediments is insufficient. This method is focused on lifting back to the surface the oil that has settled to the bottom of the reservoir in order to allow for the subsequent cleaning of the top and subsurface layers of water.

### SUMMARY OF THE INVENTION

The primary technical issue addressed by the present invention is the development of an ecologically safe and technologically simple method for the biological cleaning of oil-contaminated bottom sediments in reservoirs and water-currents and also of the bottom sediments of sludge pits and oil refining sewage tanks without the necessity of extracting the sediments from the body of water. This method can provide an increase in the effectiveness of cleaning such that the residual content of oil in the bottom sediments is no more than 1.0 g/kg.

The primary technical problems associated with many other methods of cleaning bottom sediments are solved through the utilization of a method of biological cleaning of bottom sediments utilizing worms from the Tubificidae family. This method includes aeration and/or flotation of bottom sediments and placement of mineral fertilizers following the preliminary extraction of liquid oil from the bottom of the reservoir. Release of oligochaetes of the family Tubificidae in a quantity from 20 up to 65 g/m² and simultaneously disbursing nitric and phosphoric mineral fertilizers to reach a concentration of phosphorus in the water of 0.5-1.5 mg/dm³ and nitrogen no more than 2 mg/dm³ are key features of this method.

This method of cleaning bottom sediments is carried out as follows: the liquid fraction of oil is extracted from the bottom of the reservoir, then the oligochaetes of the family Tubificidae in a quantity from 20 up to 65 g/m² (depending on the initial level of pollution and the type of bottom sediments) are placed. Nitric and phosphoric mineral fertilizers are dispersed for activation of native microflora, which facilitates both decomposition of the oil, and is the food for the worms. It is necessary to maintain a concentration of phosphorus in the water within 0.5-1.5 mg/dm³. The concentration of nitrogen in the water should be no more than 2 mg/dm³ due to the specifications of the maximum permissible concentration of chemical substances for reservoirs of culinary drinking water and water for community use.

For optimal survival of the worms, dissolved oxygen in benthic layers of water not less than 5 mg/l by aeration of reservoirs with use of aerating devices is necessary. Preferably aeration begins within 24 hours of worm placement. However, aeration may also be conducted, prior to placement or immediately following placement, as dictated by the oxygen content of the benthic layers. Aeration may be delayed beyond 24 hours, or eliminated entirely, where the water is highly oxygenated by mechanical agitation, pumping or natural movement.

Two species of worms from the family Tubificidae that may be used are Limnodrilus hoffineisteri and Tubifex tubifex, which are some of the most widespread and numerous species of worms. These worms possess distinctively high ecological plasticity and they occupy nearly all bodies of fresh water. These worms live in various soils and depths at various concentrations of oxygen. As they burrow into the bottom sediments, the worms loosen the soil. While eating the ground from deeper layers, the worms during defecation, throw it out on the surface of the bottom of the body of water, thus also loosening the soil. Milling of the bottom sediments caused by digging of live organisms or bioturbation, breaks down the various connections between the particulates forming the bottom sediment, the biotubation also influences the relationship between bottom sediments and water. Upon the implementation of this proposed method for cleaning, there is no necessity for the regulation of the water temperature, as representatives of the family Tubificidae are common inhabitants of reservoirs ranging from regions with moderate through boreal climates. The duration of a cycle of cleaning takes approximately 30 days before achieving a residual concentration of oil in bottom sediments less than 1.0 g/kg.

A first example of the application of this method researchers conducted an experiment on the possibility of using worms from the family Tubificidae in the biological cleaning of oil-contaminated bottom sediments with Limnodrilus hoffmeisteri Claparede. Duration of the experiment was from 30 to 90 days from the beginning of cultivating of worms. As a substratum for worms the lake mud and mix of mud with sand in the ratio 1:1 was used.

Homogenized mud (400 g) was distributed to the bottom of an aquarium with oil contamination in concentration from 0.836 to 16.720 g/kg of bottom sediments (in calculation on air-dry weight) and carefully mixed with a scoop for 5 minutes. The contaminated mud was in the aquariums for 7 days to allow for the process of mud-oil occlusion; daily mixing of the mud for 5 minutes was conducted. Seven days after pollution of the mud, 3 liters of running water were filled in. In each aquarium the researchers brought mineral fertilizers—ammoniac saltpeter and superphosphate. Aquariums were aerated 15-17 hours per day. The average temperature in aquariums was sustained at 23.8±0.2° C.; content of oxygen 7-8 mg/l. In some of the aquariums they placed 0.46 g or 1.5 g of adult Limnodrilus hoffmeisteri (20 and 65 g/m² accordingly), others were left without worms.

In the aquariums where the worms were not placed the results of measuring the average thickness of the layer of mud was 12.10±0.11 mm. In the aquariums with worms, the thickness of the layer of mud visually differed and was measured at 19.83±0.15. The thickness of a layer in the aquariums with worms statistically differed from the layer in the aquariums without worms (t-criterion Student, p <0.001). The Limnodrilus survived at a high concentration of oil. In all of the aquariums with worms, an abundance of Limnodrilus (one thousand copies) were revealed. FIG. 1 presents experimental data on the concentration of oil in the bottom sediments for mud and mud with sand (1:1) at different quantities of worms from the family Tubificidae. As a result of the worms, the concentration of oil in bottom sediments decreased from 1.9 to 19.9 times (depending on initial level of pollution, quantity of worms and type of bottom sediments) and reduced the concentration to no more than 1.0 g/kg after a cleaning period of 90 days.

During a second example of the application of this method, researchers engaged in the cleaning of a reservoir with an area of 1.7 hectares, average depth 1.5 m, in conditions of North West Siberia. The average content of oil in the bottom sediments prior to the beginning of the cleaning was 81.4 g/kg. Bottom sediments of the reservoir were made up of sandy mud.

The initial stage of cleaning work was carried out through the separation of oil from bottom sediments by flotation. An air-water mixture was injected into the bottom sediments using a flexible hose, allowing the liquid portion of the entrained oil to rise to the surface. The floating oil was then removed using a skimmer and separation tank assembly as commonly known in the art. As a result of flotation cleaning of the bottom, the content of oil in bottom sediments was decreased by 7.4 times and reached on average 11.0 g/kg.

After extracting oil from the bottom sediments, worms of the family Tubificidae (Limnodrilus sp.) in quantity 30 g/m² were placed into the reservoir. The quantity of worms per 1 hectare was 300 kg or 510 kg for the entire reservoir.

In order to increase the microbic decomposition of the oil for all of the water area of the reservoir, aeration by means of an aerator with total output of 12 kg O₂/hour, with a capacity of 11 kW. Thus was provided a concentration of the dissolved oxygen of not less than 8 mg/dm³.

In order to support the concentration of biogenic substances in the water at an optimal level the researchers also dispersed mineral fertilizers in the reservoir. The initial content of ions of ammonium in the water was, on the average, 0.25 mg/dm³ and the content of ions of nitrate was 0.2 mg/dm³ that in recalculation to free nitrogen results, on the average, at 0.12 mg/dm³. The necessary dose of ammoniac saltpeter to reach a concentration of nitrogen of 2.0 mg/dm³ was estimated to be 80.5 kg/hectares or 136.9 kg for the whole reservoir. Concentration of phosphate-ions in the water was 0.5 mg/dm³. To raise the concentration of phosphorus in the water to 1 mg/l in recalculation of P₂O₅ it required 24.7 kg of superphosphate per 1 hectare or 42.0 kg for the whole reservoir.

As a result of the application of this method of biological cleaning utilizing worms from the family Tubificidae together with aeration and the application of mineral fertilizers, the concentration of oil in bottom sediments after 78 days decreased to 0.97 g/kg. Thus, this method decreased the content of oil in bottom sediments more than 83 times in comparison with the initial concentration.

### BRIEF DESCRIPTION OF THE DRAWINGS

FIG. 1—Table of results for first example.

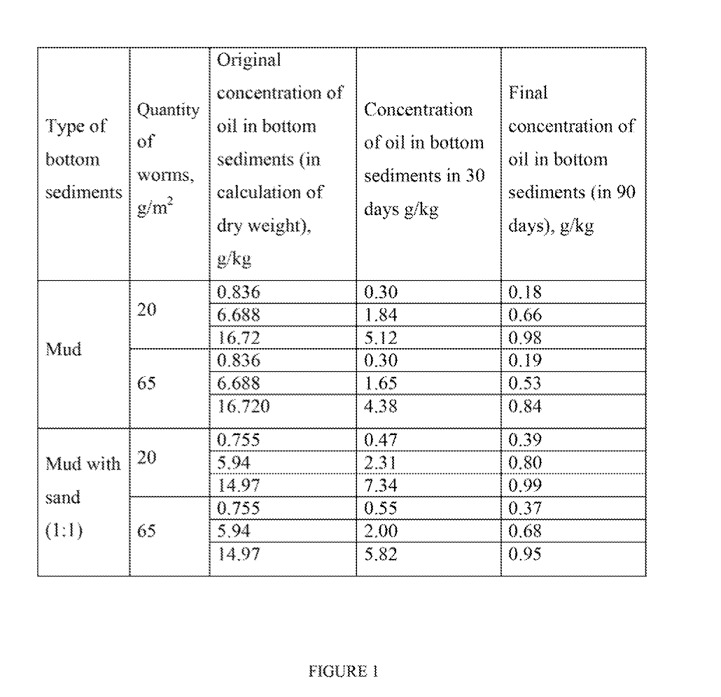

FIG. 2—Method of biological cleaning of bottom sediments flow chart.

### DETAILED DESCRIPTION OF THE INVENTION

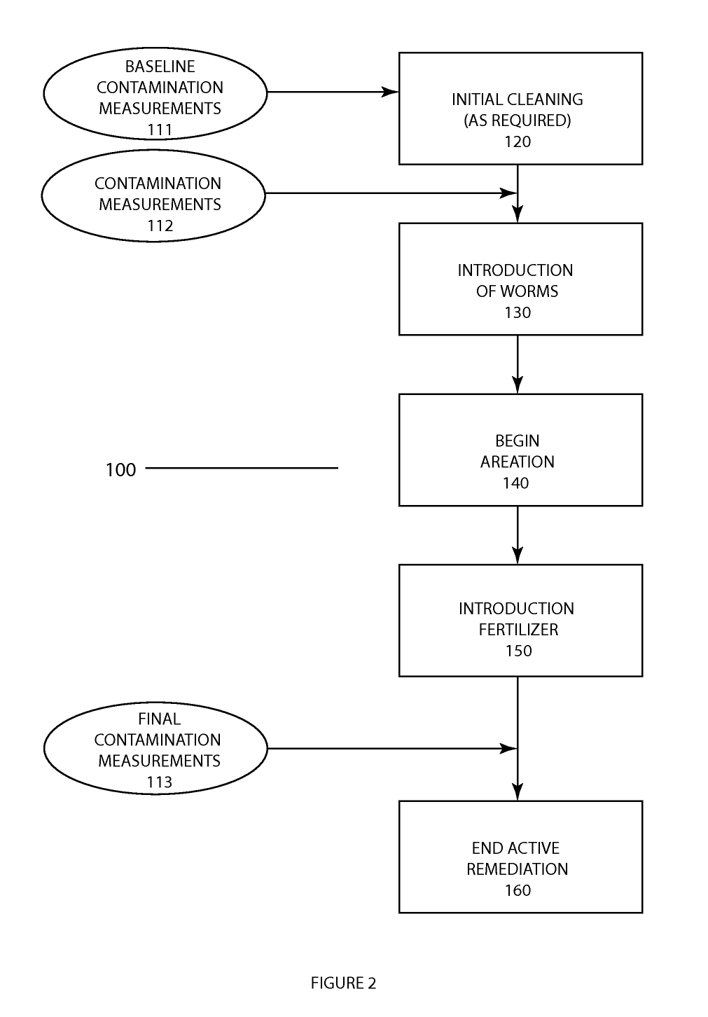

The present method of invention for the biological cleaning of underwater bottom sediments 100, as shown in FIG. 2, allows for remediation of oil spills without removal or total disturbance of underwater bottom sediments. This method can provide an increase in the effectiveness of cleaning bottom sediment until the residual oil content of the bottom sediment is less than 1.0 g/kg.

After the identification of a suitable site for the method, initial contamination measurements and assessments 111 are undertaken. Where the oil contamination is in excess of 20 g oil per kg of sediment, it is recommend that initial cleaning 110 of the sediment is conducted. This may be completed using methods commonly known in the art, such as pumping or agitation of the bottom sediment and mopping or skimming the water surface.

One method for initial cleanup may include surrounding the surface area of the water to be treated with floating containment booms or curtains. Then pressurized air, water or a combination of air and water may be used to agitate the bottom sediments and allow any liquid portion of entrained oil to float to the surface. Any floating oil may then be mopped up using absorbent mats or booms or may be skimmed using manual or mechanical means. A floating mechanical skimmer may be incorporated where water is drawn over a weir in the skimmer by pumping and the skimmed portion is transferred into an oil separator tank system where the oil is retained and the processed water is returned to body of water being treated. Secondary contamination measurements 112 can be taken to assess the effectiveness of the cleanup any time during the process. Once the oil to sediment contamination is at 20 g/kg or below, the method can be continued.

Waterborn earthworms or oligochaeles from the family Tubificidue are introduced into the contaminated water and bottom sediments 120 in a quantity of 20 g/m² up to 65 g/m² depending on the degree of contamination. Two species of worm that may be used are Limnodrilus hoffmeisteri and Tubifex tubifex which are commonly found in most bodies of fresh water. However, it is noted that other species of Tubificidae are suitable for completion of the method as well as other worms from other families or other bottom milling invertebrates and insects may also be suitable. Additionally, other marine or saltwater worms or bottom milling species may be used for oil spill remediation in a saltwater environment. The worms once introduced 120, will proceed to burrow into the soil and defecate contaminated soil onto the surface of the bottom sediment, this effectively breaks up bonded sedimentary particles and debris, allowing entrained oil to escape and enabling other microorganisms to become entrenched in the soil and facilitate bioremediation of the contaminated sediments. Additionally, the worms may partially breakdown oil molecules during the digestion process or living microorganisms in the digestive tract of the worms may also facilitate decomposition of the oil.

Oxygen quality of the water is essential for the activity and production of the worms. While the species of Tubificidae used in the method are tolerant of low oxygen quality, they will be more active and productive if additional oxygen is introduced into the water 140. Levels of dissolved oxygen in the benthic layers of the water should not be less than 5 mg/l for optimal worm production and activity. Oxygen can be introduced by conventional methods of agitation or by using forced air injected into the bottom sediments. The oxygen can be introduced into the contaminated water prior to planting the worms or after planting the worms. However, it is recommended that oxygenation of the water is started within the first 24 hours to ensure survival of the worms. In situations where the water is already highly oxygenated, such as in a river or stream, additional oxygenation may not be required.

Nitric and phosphoric mineral fertilizer is also introduced into the water 150 for the activation of the native microflora. The microflora aids in the decomposition of the oil and is also a food for the worms. It is necessary to maintain a concentration of phosphorus in the water within 0.5-1.5 mg/dm³. Nitrogen must be present for the microflora, however, the concentration of nitrogen in the water should be less than 2 mg/dm³. Water sample analysis is required to determine the proper amount of fertilizer added to the water to meet the above criteria.

The contaminated bottom sediments will become progressively cleaner using this method of bioremediation until oil content in the bottom sediments is essentially zero. Samples of the contaminated soil can be taken periodically until a final contamination measurement 113 reaches a target amount of oil per volume of sediment and active remediation 160 can be discontinued.

It will be obvious to those having skill in the art that many changes may be made to the details of the embodiments without departing from the underlying principles of the invention. The scope of the invention should, therefore, be determined only by the following claims.

1. A method for the biological cleaning of underwater oil contaminated bottom sediments comprising:
introducing a quantity of worms into the contaminated bottom sediments.

2. The method of claim 1 where in the worms are oligochaetes of the family tubificidae.

3. The method of claim 1 wherein the quantity of worms is between 20 g/m² and 65 g/m².

4. The method of claim 1 including introducing nitric and phosphoric mineral fertilizers to maintain a concentration of phosphorus in the water between 0.5 mg/dm³ and 1.5 mg/dm³ and nitrogen between 0.1 mg/dm³ and 2.0 mg/dm³.

5. The method of claim 4 wherein the nitric and phosphoric mineral fertilizers are introduced simultaneously into the water with the quantity of worms.

6. The method of claim 1 including aeration of the bottom sediments.

7. The method of claim 6 wherein the aeration is started within twenty four hours of introducing the worms.

8. The method of claim 1 including extraction of a liquid faction oil from the bottom sediments prior to introduction of the worms.
